(19) United States
(12) Patent Application Publication
(10) Pub. No.: US 2009/0021039 A1
(43) Pub. Date: Jan. 22, 2009

(54) VEHICLE GATE ASSEMBLY WITH CARGO TRAY

(76) Inventors: Douglas J. Quigley, Rochester, MI (US); Robert S. Smyczynski, Metamora, MI (US); Michael A. Kornilov, Bruce, MI (US); Todd McKinzie, Goodrich, MI (US); Clifford Wilkins, Rochester Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/778,120

(22) Filed: Jul. 16, 2007

(51) Int. Cl. B60J 5/12

(52) U.S. Cl. 296/57.1

(57) ABSTRACT

A vehicle gate assembly for a vehicle that includes a first coupling member that is movably coupled to the vehicle. The vehicle gate assembly also includes a second coupling member and a gate that is movably coupled to the vehicle via the first coupling member so as to move between a raised position and a lowered position. The gate moves away from the vehicle when moving from the raised position to the lowered position. The gate assembly also includes a tray assembly that is movably supported by the vehicle, so as to move between a retracted position and an extended position. The tray assembly is coupled to the gate via the second coupling member such that movement of the gate between the raised and towered position coincidentally moves the tray assembly between the extended position and the retracted position.

### FIELD

The present disclosure relates to vehicle gate assembly and, more particularly, to a vehicle gate assembly with cargo tray.

### BACKGROUND

It is known to provide a vehicle with a movably attached gate. For instance, trucks, minivans, and sport utility vehicles (SUVs) often include a rear tailgate rotatably attached to the vehicle body. The tailgate rotatably moves between a generally vertical, raised position and a generally horizontal, lowered position. With the tailgate in the lowered position, objects can be moved into and out of the rear cargo area of the vehicle, and with the tailgate in the raised position, objects in the cargo area are inhibited from moving out of the vehicle.

In some vehicles, the pivot axis of the tailgate is static relative to the vehicle body. However, this aspect can detrimentally affect the aesthetics of the tailgate and/or vehicle body. Also, this aspect can undesirably limit the configuration of the vehicle. For example, the potential size and location of the bumper are typically limited such that the tailgate can pivot to the generally horizontal lowered position without interfering with the bumper.

In other cases, a gooseneck hinge or the like is employed such that the tailgate swings away from the vehicle body and moves unimpeded to the lowered position. However, a significant gap can result between the tailgate and the vehicle body when the tailgate is in the lowered position. This gap can detrimentally affect the aesthetics of the vehicle. The gap can also impede movement of objects into and out of the vehicle.

Accordingly, there remains a need for an improved vehicle gate assembly that moves unimpeded relative to the vehicle body and that reduces gaps between the gate and the vehicle body to thereby improve aesthetics of the vehicle and to thereby aid in loading and unloading of cargo.

### SUMMARY

A vehicle gate assembly for a vehicle includes a first coupling member that is movably coupled to the vehicle. The vehicle gate assembly also includes a second coupling member and a gate that is movably coupled to the vehicle via the first coupling member so as to move between a raised position and a lowered position. The gate moves away from the vehicle when moving from the raised position to the lowered position. The gate assembly also includes a tray assembly that is movably supported by the vehicle so as to move between a retracted position and an extended position. The tray assembly is coupled to the gate via the second coupling member such that movement of the gate between the raised and lowered position coincidentally moves the tray assembly between the extended position and the retracted position.

In another aspect of the invention, a vehicle gate assembly for a vehicle includes a first coupling member that is movably coupled to the vehicle. The vehicle gate assembly also includes a second coupling member and a gate that is movably coupled to the vehicle via the first coupling member so as to move between a raised position and a lowered position. The vehicle gate assembly also includes a tray assembly that is movably supported inside the vehicle so as to move between a retracted position inside the vehicle and an extended position at least partially outside the vehicle. The tray assembly is coupled to the gate via the second coupling member such that movement of the gate between the raised and lowered position coincidentally moves the tray assembly between the extended position and the refracted position.

In yet another aspect of the invention, a vehicle gate assembly for a vehicle includes a first coupling member that is rotatably coupled to the vehicle. The vehicle gate assembly includes a second coupling member and a gate that is coupled to the first coupling member at a first coupling point so as to move between a raised position and a lowered position. The first coupling point moves away from the vehicle when moving from the raised position to the lowered position. The vehicle gate assembly further includes a tray assembly that is slidably supported by the vehicle so as to slide between a retracted position and an extended position. The tray assembly is coupled to the gate via the second coupling member such that movement of the gate between the raised and lowered position coincidentally slides the tray assembly between the extended position and the retracted position.

Further areas of applicability of the present disclosure will become apparent from the detailed description provided hereinafter, it should be understood that the detailed description and specific examples, while indicating embodiments) of the invention, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle with one embodiment of a vehicle gate assembly shown in a raised position;

FIG. 2 is a perspective view of the vehicle of FIG. 1 with the vehicle gate assembly shown in the lowered position;

FIG. 3 is a perspective view of the vehicle of FIG. 1, wherein the vehicle gate assembly includes a tray assembly with a net; and

FIGS. 4a, 4b, and 4c are partial side views of the vehicle of FIG. 1 illustrating movement of the gate assembly relative to the vehicle body, wherein FIG. 4a shows the gate assembly in a raised position, FIG. 4b shows the gate assembly in an intermediate position, and FIG. 4c shows the gate assembly in the lowered position.

### DETAILED DESCRIPTION

The following description of the embodiment(s) is merely exemplary in nature and is in no way intended to limit the invention, its application, or uses.

Referring to the FIGS., a vehicle 10 is illustrated. The vehicle 10 includes a vehicle body 12 and a vehicle gate assembly 14. It will be appreciated that the vehicle 10 could be of any suitable type, such as a minivan, a sport utility vehicle (SUV), a pickup truck, etc, without departing from the scope of the present disclosure.

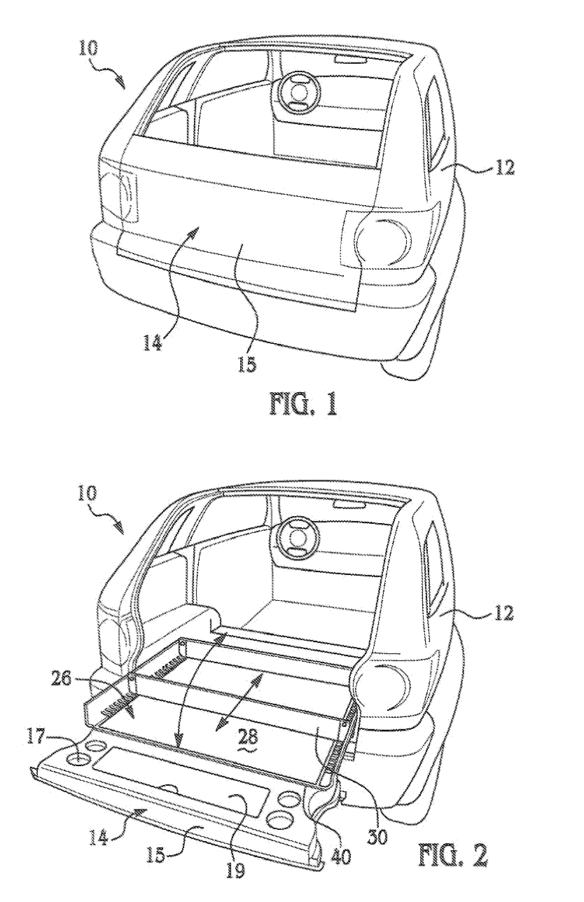

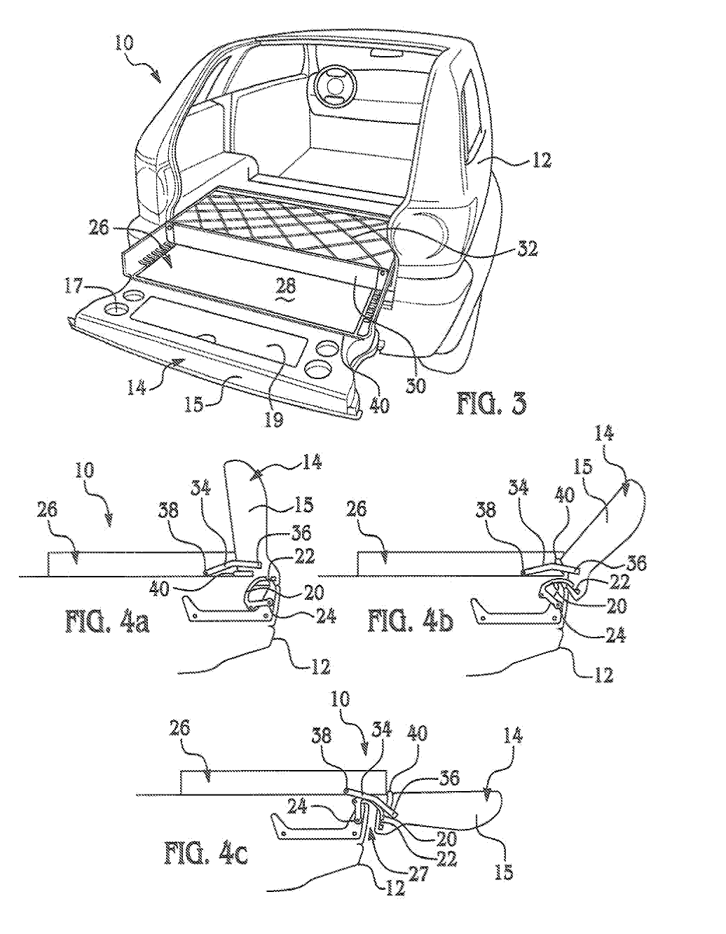

The vehicle gate assembly 14 includes a gate 15. The gate 15 is movably coupled to the vehicle body 12. In the embodiment shown, the gate 15 is rotatably coupled to the vehicle body 12 so as to move between a raised position (FIGS. 1 and 4a) and a lowered position (FIGS. 2, 3, and 4c) as will be described in greater detail below.

In the embodiment shown, the gate 15 is coupled to the rear end of the vehicle body 12 so as to open and close a cargo area of the vehicle 10. Also, in the embodiment shown, the gate 15 includes a plurality of recesses 17 for holding various objects. For instance, when the gate 15 is in the lowered position, cups or like objects can be retained within the recesses 17. Also, the gate 15 includes an internal compartment 19 inside the gate 15 for storage of larger objects within the gate 15.

The vehicle gate assembly 14 also includes a first coupling member 20 shown in FIGS. 4a-4c. The first coupling member 20 is movably coupled to the vehicle body 12 and is also movably coupled to the gate 15. As such, the gate 15 is movably coupled to the vehicle body 12 via the first coupling member 20.

As shown in the embodiment of FIGS. 4a-4c, the first coupling member 20 is generally U-shaped. One terminal end of the first coupling member 20 is fixed to the gate 15 to define a first coupling point 22. An opposite terminal end of the first coupling member 20 is rotatably and pivotally coupled to the vehicle body 12 to define a second pivot axis 24. As such, the gate 15 is rotatably coupled to the vehicle body 12 via the first coupling member 20. It will be appreciated that FIGS. 4a-4c show only one side of the vehicle gate assembly 14 and as such, only one first coupling member 20 is shown. However, it will be appreciated that the opposite side of the vehicle gate assembly 14 includes a similar first coupling member 20.

More specifically, as the gate 15 moves from the raised position to the lowered position, the first coupling member 20 rotates about the second pivot axis 24. Also, because the second pivot axis 24 and the first coupling point 22 are disposed in spaced relationship to each other, the gate 15 swings and moves away from the vehicle body 12. In other words, even though the second pivot axis 24 remains stationary relative to the vehicle body 12, the first coupling point 22 moves horizontally away from the vehicle body 12.

Furthermore, as the gate 15 moves from the lowered position to the raised position, the first coupling member 20 rotates about the second pivot axis 24. As a result, the gate 15 swings and moves toward the vehicle body 12. In other words, even though the second pivot axis 24 remains stationary relative to the vehicle body 12, the first coupling point 22 moves horizontally toward the vehicle body 12.

As such, the gate 15 is less likely to interfere with the vehicle body 12 when moving between the raised and lowered positions. Accordingly, design (e.g., dimensions) of the vehicle 10 can be varied more easily without causing interference between the gate 15 and the vehicle body 12. For instance, a larger bumper can be added to the vehicle 12, and the gate 15 can still move unimpeded by the bumper.

The vehicle gate assembly 14 also includes a tray assembly 26. In the embodiment shown, the tray assembly 26 is a cargo tray that is disposed substantially inside the vehicle body 12 and, more specifically, in a cargo area at the rear of the vehicle 10. As such, various types of cargo can be supported on the tray assembly 26 inside the vehicle 10.

As shown in FIG. 2, the fray assembly 26 includes a platform 28, which is a generally flat and horizontal surface with upturned ends for supporting cargo. The tray assembly further includes a divider wall 30, which is a generally elongate vertical wall. The divider wail 30 is movably coupled to the platform 28 for dividing space on the platform 28. In the embodiment shown, for instance, the platform 28 includes slots on each end, and the divider wall 30 removably fits within any pair of slots on the platform 28. As such, the divider wall 30 can be moved on the platform 28 to change the divided space thereon. As such, the divider wall 30 provides added versatility for storage of cargo on the tray assembly 26.

Moreover, in the embodiment shown in FIG. 3, the tray assembly 26 includes a net 32. In the embodiment shown, the net 32 is removably coupled on three sides to the platform 28, and the net 32 is coupled on the remaining side to the divider wall 30. The net 32 can be coupled in any suitable manner, such as hooks. Using the net 32, objects can be retained on the tray assembly 26.

The tray assembly 26 is movably supported by the vehicle body 12 so as to move between a retracted position inside the vehicle 10 (FIGS. 1 and 4a) and an extended position at least partially outside the vehicle (FIGS. 2, 3, and 4c). As will be discussed, the tray assembly 26 substantially closes a gap 27 (see FIG. 4c) between the gate 15 and the vehicle body 12 when the tray assembly 26 is in the extended position.

In the embodiment shown, the tray assembly 28 is slidably supported by the vehicle body 12. More specifically, the platform 28 of the tray assembly 26 slides on the inferior of the vehicle body 12. It will be appreciated that the tray assembly 26 could include slider rails or the like in order to facilitate the sliding movement of the tray assembly 26.

Furthermore, the tray assembly 26 is coupled to the gate 15 such that movement of the gate 15 between the raised position and the lowered position coincidentally moves the tray assembly 26 between the extended position and the retracted position. For instance, as shown in FIGS. 4a-4c, the vehicle gate assembly 14 includes a second coupling member 34 for coupling the tray assembly 26 to the gate 15. It will be appreciated that FIGS. 4a-4c show only one side of the vehicle gate assembly 14 and as such, only one second coupling member 34 is shown. However, it will be appreciated that the opposite side of the vehicle gate assembly 14 includes a similar second coupling member 54.

In the embodiment shown, the second coupling member 34 is generally elongate and has an axis that is nonlinear. One terminal end of the second coupling member 34 is pivotally and rotatably coupled to the gate 15 to define a third pivot axis 36, and an opposite terminal end of the second coupling member 34 is pivotally and rotatably coupled to the tray assembly 26 to define a fourth pivot axis 38. In the embodiment shown, the second coupling member 34 is pivotally coupled to the upturned side of the platform 28 of the tray assembly 26.

Thus, as the gate 15 moves from the raised position to the lowered position, the second coupling member 34 coincidentally pulls the tray assembly 26 from the retracted position to the extended position. In so doing, the platform 28 of the tray assembly 26 moves over and substantially covers the gap 27 between the gate 15 and the vehicle body 12 (see FIG. 4c). As such, vehicle aesthetics are improved because the gap 27 is less visible. Moreover, this coincidental movement of the tray assembly 26 facilitates unloading cargo from the vehicle 10 because the cargo is partially moved out of the vehicle 10 by the tray assembly 26.

Also, as the gate 15 moves from the lowered position to the raised position, the second coupling member 34 coincidentally pushes the tray assembly 26 from the extended position to the retracted position. As such, cargo can be easily loaded on the tray assembly 26 when in the extended position because the tray assembly 26 is partially outside the vehicle 10, and the coincidental movement of the gate 15 and the tray assembly 26 further facilitates loading of the vehicle because the tray assembly 26 is pushed into the vehicle by the second coupling member 34.

Furthermore, in the embodiment shown, the vehicle gate assembly 14 includes a seal member 40. The seal member 40 is fixed to the gate 15. When the gate 15 is in the raised position and the tray assembly 26 is in the retracted position, the seal member 40 seals against the vehicle body 12 (see FIG. 4a) so as to seal the gate 15 to the vehicle body 12. As such, rainwater and other fluids, etc. are less likely to leak into the vehicle 10 when the gate 15 is in the raised position. Also, when the gate 15 is in the lowered position and the tray assembly 26 is in the extended position, the platform 28 of the tray assembly 26 abuts and seals against the seal member 40 (see FIG. 4c). As such, the seal member 40 seals the gate 15 to the tray assembly 26 and ensures that the gap 27 is closed.

Thus, the gate assembly 14 of the present disclosure moves unimpeded by the vehicle body 12 between the raised and lowered position. Furthermore, the tray assembly 26 coincidentally moves out of the vehicle 10 to close the gap 27 between the gate 15 and the vehicle body 12 to thereby make the vehicle 10 more aesthetically pleasing and to facilitate unloading of the vehicle 10. Moreover, the tray assembly 26 coincidentally moves into the vehicle 10 when the gate 15 is raised to thereby facilitate loading of the vehicle.

The preceding description is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A vehicle gate assembly for a vehicle comprising:
a first coupling member that is movably coupled to the vehicle;
a second coupling member;
a gate that is movably coupled to the vehicle via the first coupling member so as to move between a raised position and a towered position, wherein the gate moves away from the vehicle when moving from the raised position to the lowered position; and
a tray assembly that is movably supported by the vehicle so as to move between a retracted position and an extended position, wherein the tray assembly is coupled to the gate via the second coupling member such that movement of the gate between the raised and lowered position coincidentally moves the tray assembly between the extended position and the retracted position.

2. The vehicle gate assembly as set forth in claim 1, wherein a gap exists between the gate and the vehicle when the gate is in the lowered position, and wherein the tray assembly substantially closes the gap when the tray assembly is in the extended position.

3. The vehicle gate assembly as set forth in claim 2, further comprising a seal member, and wherein the tray assembly abuts against the seal member when the tray assembly is in the extended position.

4. The vehicle gate assembly as set forth in claim 1, further comprising a seal member for sealing the gate to the vehicle when the gate is in the raised position and for sealing the gate to the tray assembly when the gate is in the lowered position.

5. The vehicle gate assembly as set forth in claim 1, wherein the tray assembly includes a platform and a divider wall that is movably coupled to the platform for dividing space on the platform.

6. The vehicle gate assembly as set forth in claim 1, wherein the tray assembly includes a net for retaining an object on the tray assembly.

7. The vehicle gate assembly as set forth in claim 1, wherein the tray assembly is slidably supported by the vehicle so as to slidably move between the refracted position and the extended position.

8. The vehicle gate assembly as set forth in claim 1, wherein the fray assembly moves at least partially out of the vehicle when moving from the retracted position to the extended position.

9. A vehicle gate assembly for a vehicle comprising:
a first coupling member that is movably coupled to the vehicle;
a second coupling member;
a gate that is movably coupled to the vehicle via the first coupling member so as to move between a raised position and a lowered position; and
a tray assembly that is movably supported inside the vehicle so as to move between a retracted position inside the vehicle and an extended position at least partially outside the vehicle, wherein the tray assembly is coupled to the gate via the second coupling member such that movement of the gate between the raised and lowered position coincidentally moves the tray assembly between the extended position and the retracted position.

10. The vehicle gate assembly as set forth in claim 9, wherein the gate moves away from the vehicle when moving from the raised position to the lowered position.

11. The vehicle gate assembly as set forth in claim 9, wherein a gap exists between the gate and the vehicle when the gate is in the lowered position, and wherein the tray assembly substantially closes the gap when the tray assembly is in the extended position.

12. The vehicle gate assembly as set forth in claim 11, further comprising a seal member, and wherein the tray assembly abuts against the seal member when the tray assembly is in the extended position.

13. The vehicle gate assembly as set forth in claim 9, further comprising a seal member for sealing the gate to the vehicle when the gate is in the raised position and for sealing the gate to the tray assembly when the gate is in the lowered position.

14. The vehicle gate assembly as set forth in claim 9, wherein the tray assembly includes a platform and a divider wall that is movably coupled to the platform for dividing space on the platform.

15. The vehicle gate assembly as set forth in claim 9, wherein the tray assembly includes a net for retaining an object on the tray assembly.

16. The vehicle gate assembly as set forth in claim 9, wherein the tray assembly is slidably supported by the vehicle so as to slidably move between the retracted position and the extended position.

17. A vehicle gate assembly for a vehicle comprising:
a first coupling member that is rotatably coupled to the vehicle;
a second coupling member;
a gate that is coupled to the first coupling member at a first coupling point so as to move between a raised position and a lowered position, wherein the first coupling point moves away from the vehicle when moving from the raised position to the lowered position; and
a tray assembly that is slidably supported by the vehicle so as to slide between a retracted position and an extended position, wherein the tray assembly is coupled to the gate via the second coupling member such that movement of the gate between the raised and lowered position coincidentally slides the tray assembly between the extended position and the retracted position.

18. The vehicle gate assembly as set forth in claim 17, wherein a gap exists between the gate and the vehicle when the gate is in the lowered position, and wherein the tray assembly substantially closes the gap when the tray assembly is in the extended position.

19. The vehicle gate assembly as set forth in claim 17, further comprising a seal member for sealing the gate to the vehicle when the gate is in the raised position and for sealing the gate to the tray assembly when the gate is in the lowered position.
